(19) United States
(12) Patent Application Publication
(10) Pub. No.: US 2018/0178460 A1
(43) Pub. Date: Jun. 28, 2018

(54) Joining Method and Apparatus

(71) Applicant: AIRBUS GROUP LIMITED, London (GB)

(72) Inventors: Philip Nicholas PARKES, Bath (GB); Jonathan MEYER, Wiltshire (GB)

(21) Appl. No.: 15/852,893

(22) Filed: Dec. 22, 2017

(30) Foreign Application Priority Data
Dec. 23, 2016 (GB) 1622130.1

(51) Int. Cl. B29C 65/48; B29C 65/02; B29C 65/00

(52) U.S. Cl. CPC B29C 65/48; B29C 66/00145; B29C 65/02

(57) ABSTRACT

A method of joining a first component to a second component. A membrane is provided between the first component and a fluid. Pressure of the fluid is used to apply a compression force to a first part of the first component via the membrane. The pressure of the fluid is also used to apply an insertion force to the second component which pushes projections of the second component into a second part of the first component. The method can be integrated into a conventional manufacturing method, such as a “vacuum-bagging” process, which employs fluid pressure and a non-permeable membrane to compress the first component. The pressure of the fluid is used not only to apply the compression force, but also to apply the insertion force to the second component.

### FIELD OF THE INVENTION

The present invention relates to a method, and associated apparatus, for joining a first component to a second component, in which projections of the second component are pushed into the first component. The first component is typically, although not exclusively, a composite component.

### BACKGROUND OF THE INVENTION

A known method of joining a first component to a second component is described in FIG. 5a of WO 2010/122325. An interface plate is attached to an uncured composite component by pushing pointed prongs of the interface plate into the uncured composite component.

Another method of joining a first component to a second component is described in FIG. 7 of US 2014/0020826. A rib foot is integrated into a mould tool, and a composite lay-up is laid onto the mould tool so that the initial prepregs are penetrated by projections of the rib foot. After the lay-up has been formed, it is cured and consolidated by a so-called “vacuum bagging” process in which the lay-up is covered by a vacuum membrane.

### SUMMARY OF THE INVENTION

A first aspect of the invention provides a method of joining a first component to a second component, the method comprising: providing a membrane between the first component and a fluid; using pressure of the fluid to apply a compression force to a first part of the first component via the membrane; and also using the pressure of the fluid to apply an insertion force to the second component which pushes projections of the second component into a second part of the first component.

The method can be integrated into a conventional manufacturing method, such as a “vacuum-bagging” process, which employs fluid pressure and a non-permeable membrane to compress the first component—for instance to mould or consolidate the first component. The pressure of the fluid is used not only to apply the compression force to the first component, but also to apply the insertion force to the second component. This provides a more simplified manufacturing process than US 2014/0020826 which only lays the vacuum membrane onto the lay-up after the components have been joined by embedding the projections of the rib foot in the lay-up.

Typically the fluid is a gas, such as air in an autoclave chamber. Alternatively the fluid may be a liquid.

Optionally the pressure of the fluid exceeds 3 bar (0.3 MPa) and preferably it exceeds 5 bar (0.5 MPa).

Optionally the first component is a composite component comprising fibres impregnated with a matrix material. Alternatively the first component may be made from a non-composite material.

Typically the pressure of the fluid causes a fluid pressure difference across the membrane, and the fluid pressure difference across the membrane generates the compression force.

In some embodiments of the present invention, the pressure of the fluid applies the compression force and the insertion force via first and second second parts of the membrane respectively. The second part of the membrane may apply the insertion force directly to the second component, or it may apply the insertion force via an insertion member such as a cap.

Where an insertion member is used, then optionally the pressure of the fluid causes a fluid pressure difference across the membrane; and an insertion pressure applied by the insertion member to the second component is greater than the fluid pressure difference across the membrane. Typically the fluid pressure difference P1 across the membrane is applied by the second part of the membrane to the insertion member over a first area A1 so that the insertion force F=P1*A1, and the insertion force F is applied by the insertion member to the second component over a second area A2 which is less than A1 so that an insertion pressure P2=F/A2 applied by the insertion member to the second component is greater than the fluid pressure difference P1 across the membrane.

Typically the insertion member is disengaged from the second component after it has applied the insertion force to the second component and the projections of the second component have been pushed into the first component.

In other embodiments of the present invention, an insertion member is provided; the pressure of the fluid causes a fluid pressure difference across the insertion member; and the fluid pressure difference across the insertion member generates the insertion force rather than a fluid pressure difference across the membrane. The insertion member is typically disengaged from the second component after it has applied the insertion force to the second component and the projections of the second component have been pushed into the first component.

Optionally an insertion pressure applied by the insertion member to the second component is greater than the fluid pressure difference across the insertion member. For instance the fluid pressure difference P1 across the insertion member acts over a first area A1 so that the insertion force F=P1*A1, and the insertion force F is applied by the insertion member to the second component over a second area A2 which is less than A1 so that the insertion pressure P2=F/A2 applied by the insertion member to the second component is greater than the fluid pressure difference P1 across the insertion member.

In a further embodiment of the present invention, the pressure of the fluid causes a fluid pressure difference across the second component; and the fluid pressure difference across the second component generates the insertion force rather than a fluid pressure difference across the membrane or an insertion member.

The projections of the second component are typically pointed projections.

Optionally the method further comprises fitting the second component into a guide tool; and guiding the second component with the guide tool as the projections of the second component are pushed into the second part of the first component. Optionally the guide tool also contacts the first component as the projections of the second component are pushed into the second part of the first component.

The membrane typically applies the compression force to at least part of the first component via the guide tool. In this case, then optionally the guide tool has a skirt with a tapered bending stiffness which applies the compression force.

In some embodiments of the present invention, the guide tool is fitted into a hole in the membrane; and the membrane is sealed to the guide tool around a periphery of the hole to provide a fluid-tight seal between the guide tool and the membrane so that the fluid cannot leak between the membrane and the guide tool.

Typically the method further comprises curing the first component after the projections of the second component have been pushed into the second part of the first component. This curing process adheres the second component to the first component. Optionally the method further comprises continuing to use the pressure of the fluid to apply the compression force to the first part of the first component via the membrane as the first component cures.

The first component may comprise a thermosetting material, such as epoxy resin, which is cured by heating. Alternatively the first component may comprise a thermoplastic material which is softened by heating and then cured by allowing it to cool.

Optionally the method further comprises heating the first component so that the second component is at an elevated temperature as the projections of the second component are pushed into the second part of the first component.

The compression force is typically applied to the first part of the first component at the same time as the projections of the second component are pushed into a second part of the first component.

Optionally the insertion force caused by the pressure of the fluid is supplemented by the action of a mechanical ram or other device.

In a preferred embodiment the insertion force caused by the pressure of the fluid pushes the tips of the projections of the second component through a surface of the second part of the first component, and then further into the second part of the first component. Typically the second part of the first component comprises fibres which are pushed apart by the projections as the projections are pushed into the second part of the first component. Optionally the fibres are impregnated with a matrix material (thermosetting or thermoplastic) which is pierced by the projections as the projections are pushed into the second part of the first component. Alternatively the fibres may be dry fibres. In this case, during or after the insertion of the projections a liquid matrix material (thermosetting or thermoplastic) may be introduced into the first component to infuse the dry fibres and then cure to form an adhesive bond with the second component.

Typically the projections of the second component are metallic.

In a preferred embodiment the second component has a body; and the projections extend from the body. Optionally the body and the projections are made of the same material. Optionally the body is metallic and the projections are metallic. In a preferred embodiment the projections do not penetrate the body—in other words they are not Z-pins or other reinforcement elements which penetrate the body as well as the first component. The method may comprise increasing the pressure of the fluid in order to generate the compression force and the insertion force. Alternatively the compression force and the insertion force may be generated by evacuating a low-pressure volume on an opposite side of the membrane to the fluid.

Typically the projections of the second component are pushed into the second part of the first component without passing through the second part of the first component. In other words, tips of the projections become embedded in the first component without passing fully through the first component. Alternatively the insertion force may push the projections of the second component into the first component so that the tips of the projections pass fully through the first component to the other side.

A further aspect of the invention provides apparatus for joining a first component to a second component by the method of the first aspect, the apparatus comprising: a membrane; and a guide tool with a parallel-sided bore for receiving the second component and guiding the second component as the projections of the second component are pushed into the first component.

The parallel-sided bore may have a constant cross-section (for instance square or circular) or it may have a more complex shape with a cross-section which varies along its length. The bore has parallel sides which guide the second component in a required insertion direction. The parallel sides may be planar (in the case of a parallel-sided bore with a square cross-section) or curved (in the case of a parallel-sided bore with a circular cross-section).

Optionally the guide tool has a skirt with a tapered bending stiffness for applying the compression force to the first component.

In some embodiments the guide tool is fitted into a hole in the membrane; and the membrane is sealed to the guide tool around a periphery of the hole to provide a fluid-tight seal between the guide tool and the membrane.

In some embodiments the apparatus comprises a cap fitted onto the guide tool covering the bore, wherein the cap is slidably fitted onto the guide tool so the cap can move in a sliding direction towards the bore, the cap has a face directed away from the bore, the face has an area A1, the bore has a cross-sectional area A2 transverse to the sliding direction, and the area A1 is greater than the area A2. Optionally a seal member, such as an O-ring, provides a fluid-tight seal between the cap and the guide tool.

### BRIEF DESCRIPTION OF THE DRAWINGS

Embodiments of the invention will now be described with reference to the accompanying drawings, in which:

FIG. 1 is an exploded view showing a master tool, composite component, guide tool, metal component and cap;

FIG. 2 shows the elements of FIG. 1 assembled;

FIG. 3 is a schematic plan view of the composite component;

FIG. 4 shows the metal component inserted in the composite component;

FIG. 5 is a plan view of a square guide tool;

FIG. 6 is a plan view of a cylindrical guide tool;

FIG. 7 is a sectional view of the top ply of the composite component after the projections have been inserted;

FIG. 8 is a sectional view showing fibres deflected by one of the projections;

FIG. 9 shows an alternative guide tool with a tapered rubber skirt;

FIG. 10 shows an alternative arrangement prior to insertion of the projections;

FIG. 11 shows the arrangement of FIG. 10 after insertion; and

FIG. 12 shows an alternative arrangement with no cap.

### DETAILED DESCRIPTION OF EMBODIMENT(S)

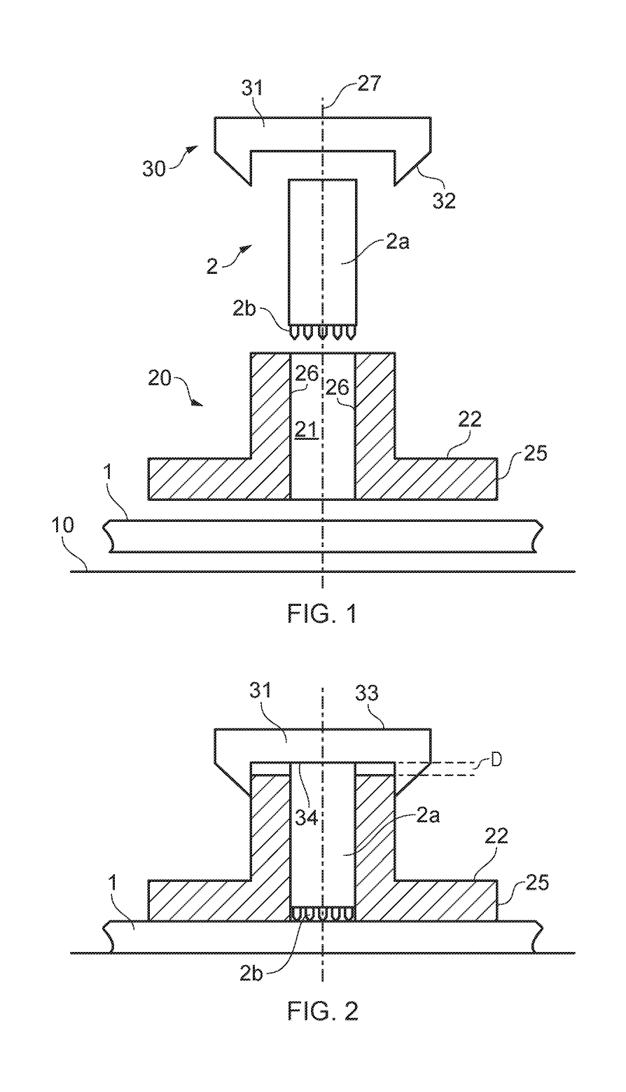

FIGS. 1 to 4 shows a method of joining a first component 1 to a second component 2 according to a first embodiment of the present invention. The first component 1 may be a dry-fibre preform or a prepreg stack. In the case of a dry-fibre preform, the first component 1 is made of dry fibres, not yet impregnated with a matrix material. In the case of a prepreg stack, the first component 1 is made of a laminated stack of plies of so-called “prepreg” composite material. Each ply of the prepreg stack comprises fibres impregnated with a matrix material which may either be thermosetting (such as epoxy resin) or thermoplastic. The second component 2 has a body 2a and pointed projections or prongs 2b extending from an underside of the body 2a. The projections 2b are typically metallic—such as titanium. Typically the body 2a and the projections 2b are made of the same material, although optionally they may be made of different materials (such as different titanium alloys). The projections 2b are illustrated with a thickness which decreases continuously at the tip, but other tip shapes are possible—for instance with an enlarged head as in US 2014/0020826.

In the embodiments described below with references to FIGS. 1 to 9, the first component 1 is made of a stack of plies of “prepreg” composite material, so it will be referred to as a composite component 1. The second component 2 will be referred to as a metal component 2.

The composite component 1 is mounted (or laid-up) on a master tool 10. The composite component 1 may be laid-up by hand or by an automated fibre placement (AFP) machine. Optionally breather layers and/or peel plies (not shown) may then be laid on top of the composite component 1. A guide tool 20 is placed on the composite component 1 on the master tool 10 as shown in FIG. 2. The guide tool 20 has a parallel-sided bore 21 with planar parallel sides 26 extending in an insertion direction 27. The body 2a of the metal component has a complementary parallel-sided outer face which engages the guide tool as a sliding fit when the metal component is fitted into the bore 21 as shown in FIG. 2. When the tips of the projections 2b touch the surface of the composite component 1 as in FIG. 2, the body 2a of the first component protrudes slightly above the top of the guide tool 20 by a distance D. The bottom of the guide tool is formed with a skirt 25 with an upper face 22.

After the metal component 2 has been fitted into the guide tool, a cap 30 with a body 31 and a peripheral flange 32 is fitted onto the guide tool 20 as shown in FIG. 2 so that it contacts the upper face of the body 2a of the metal component. The body 31 of the cap has an upper face 33 directed away from the guide tool 20 with an area A1, and a lower face 34 which contacts the upper face of the body 2a of the metal component over a second area A2. The second area A2 is approximately the same as the cross-sectional area of the bore 21 transverse to the insertion direction 27. The area A1 is greater than the area A2—in this case approximately ten times greater.

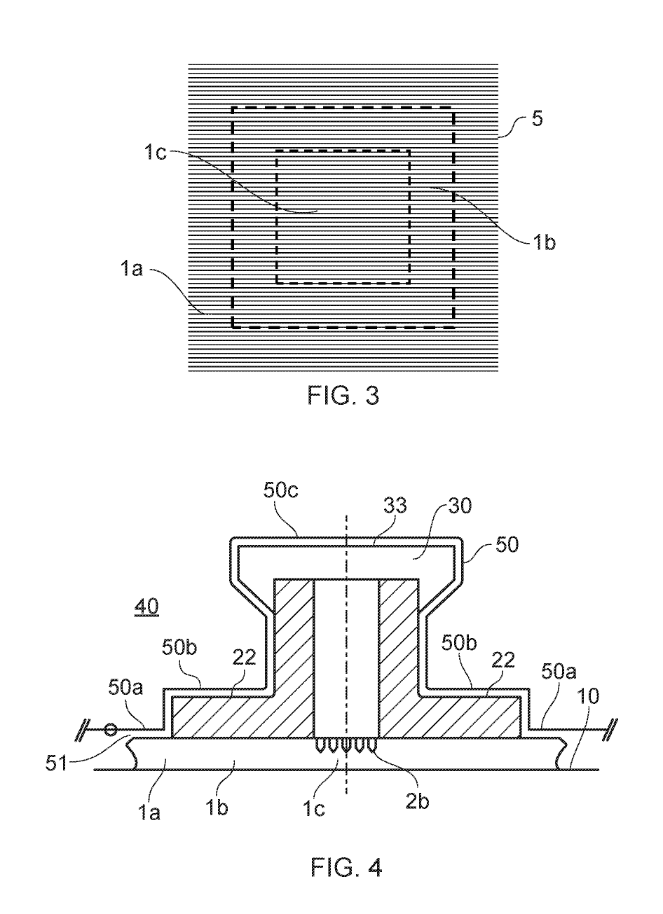

FIG. 3 is a plan view of the composite component 1, showing the top ply of the prepreg stack which has uni-directional carbon fibres 5 running from left to right in the view of FIG. 3. The other plies in the stack also have uni-directional carbon fibres, which may run at the same angle as the fibres 5 in the top ply or may run at another angle (typically at 90 or 45 degrees to the fibres in the top ply). The footprint of the guide tool 10 is shown in dashed lines. The composite component 1 has three parts 1a-1c: a central part 1c in line with the bore 21 of the guide tool; a part 1b contacted by the underside of the guide tool 10; and an outer part 1a which surrounds the guide tool 10. These three parts are also shown in FIG. 4.

Once the various elements of the apparatus have been assembled as shown in FIG. 2, they are placed in an autoclave chamber 40 shown in FIG. 4. A non-permeable membrane 50 is draped over the assembly. The membrane 50 has an outer part 50a which covers the outer part 1a of the composite component; a central part 50c which contacts the upper face 33 of the cap; and a part 50b which contacts the upper face 22 of the skirt of the guide tool. The outer part 1a of the composite component may be directly contacted by the outer part 50a of the membrane, or there may be breather layers or peel plies (not shown) between them.

The membrane 50 is sealed to the master tool 10 to provide a sealed volume 51 between the master tool 10 and the membrane 50. This sealed volume 51 will be referred to below as a low-pressure volume 51 for reasons which will become apparent. The low-pressure volume 51 contains the components 1, 2; the guide tool 20; the cap 30; and air at atmospheric pressure P1.

The autoclave chamber 40 is then heated to bring the various parts up to an elevated temperature such as 150° C. The pressure of the gas in the autoclave chamber 40 above the membrane 50 is also increased to a pressure P2 which is greater than the pressure P1 below the membrane 50 in the low-pressure volume 51. The pressure P2 may for example be 7 bar (0.7 MPa).

The high gas pressure P2 in the autoclave chamber 40 results in a pressure difference (P2−P1) across the membrane 50, because the low-pressure volume 51 between the membrane 50 and the master tool 10 remains at atmospheric pressure P1.

This pressure difference (P2−P1) across the membrane 50 generates a compression force which is applied by the membrane to the parts 1a, 1b of the composite component 1. The pressure difference across the membrane 50 also generates an insertion force F which causes the cap 30 to push the tips of the projections 2b of the second component through the surface of the composite component 1 and then further into the central part 1c of the composite component 1 until the lower face of the cap contacts the top of the guide tool 20 as shown in FIG. 4. The pressure of the air in the autoclave chamber 40 applies the compression force to the parts 1a,b of the composite component 1 via the parts 50a,b of the membrane; and it also applies the insertion force to the metal component 2 via the central part 50c of the membrane and the cap 30. The gas pressure difference P1 across the membrane is applied by the central part 50c of the membrane to the cap over a first area A1, which is the area of the upper face 33 of the cap 30, so that the insertion force F=P1*A1. This insertion force F is applied by the cap 30 to the metal component 2 over a second area A2 which is the contact area between the lower face 34 of the cap and the top of the metal component. The second area A2 is less than A1, so that an insertion pressure P2=F/A2 applied by the cap to the metal component is greater than the fluid pressure difference (P2−P1) across the membrane. This provides a convenient method of controlling the insertion force F. That is, if a high insertion force is needed then the area A1 of the upper face 33 of the cap 30 can be increased. In the example described herein, only a single metal component 2 is shown being joined to the composite component 1, but in an alternative embodiment multiple metal components may be attached to the composite component 1. These components may have different required insertion forces, for instance if they have different sizes and/or different numbers of projections. In this case each one of the metal components may be pushed in by a cap with a different area A1 which is tailored to provide the required insertion force.

The difference D between the height of the tool 20 and the height of the metal component 1 controls the insertion depth of the projections 2b. In this case the distance D is equal to the length of the projections 2b, so they are fully inserted. The length of the projections 2b is less than the thickness of the second part 1c of the composite component 1, so they become fully embedded in the composite component 1 without passing fully through the composite component 1 and into contact with the master tool 10.

The guide tool 20 guides the metal component 2, so that it travels in a straight line in the insertion direction 27 orthogonal to the composite component 1 as the projections 2b are pushed in.

The compression force is applied to the parts 1a,b of the composite component at the same time as the projections 2b are pushed in. The membrane 50 applies this compression force to the part 1b via the guide tool 20, and it applies the compression force to the part 1a either directly, or via a breather layer and/or peel ply. The compression force initially causes a certain amount of compression of the parts 1a,b of the composite component, until the forces are balanced.

The composite component 1 is at an elevated temperature (of the order of 100° C.) as the projections 2b are inserted. This allows the projections 2b to penetrate more easily and minimises distortion of the fibres as they are deflected by the projections.

After the projections have been fully inserted, the composite component 1 is cured by raising the temperature of the autoclave chamber 40 further to the curing temperature of the matrix of the composite part—for instance 180° C. The pressure P2 of the autoclave chamber is kept high during the curing process, so the gas pressure continues to apply the compression force to the composite component via the membrane 50 as the composite component consolidates and then cures. This compression force is now not only transmitted to the parts 1a,b of the composite component, but also to the central part 1c of the composite component by the underside of the body 2a of the metal component 2 which is now fully engaged. The compression force assists in consolidation of the composite material, by assisting the release of gaseous volatiles and compacting the material.

Optionally the pressure P2 of the autoclave may be ramped up gradually, along with the temperature, so there is an initial consolidation of the parts 1a,b of the composite component but little or no insertion of the projections 2b. When the pressure and/or temperature passes a certain point then the insertion force F will be sufficient to push the projections 2b into the partially consolidated composite component. The area A1 of the cap can be tailored to control the duration of this initial consolidation period.

The pressure and temperature of the autoclave are preferably controlled to perform a conventional autoclave cycle, such as:
1) ramp autoclave pressure P2 up to 7 bar (0.7 MPa) over a period of approximately 60 minutes
2) at the same time as the pressure is increased, ramp temperature up to 150° C. at a rate between 0.5-1° C./minute
3) hold the temperature at 150° C. for 180 minutes
4) ramp temperature up to 180° C. at a rate between 0.5-1° C./minute
5) hold the temperature at 180° C. for 120 minutes
6) cool at a cool rate of 2-5° C./minute
7) vent the autoclave pressure when the temperature reaches 60° C. or below

The curing of the composite component 1 results in a secure adhesive bond with the metal component 2. The resultant joint is conventionally known as a “hybrid joint”—a joint which employs two joining techniques, in this case an adhesive joint in combination with multiple mechanical joints with the pointed projections.

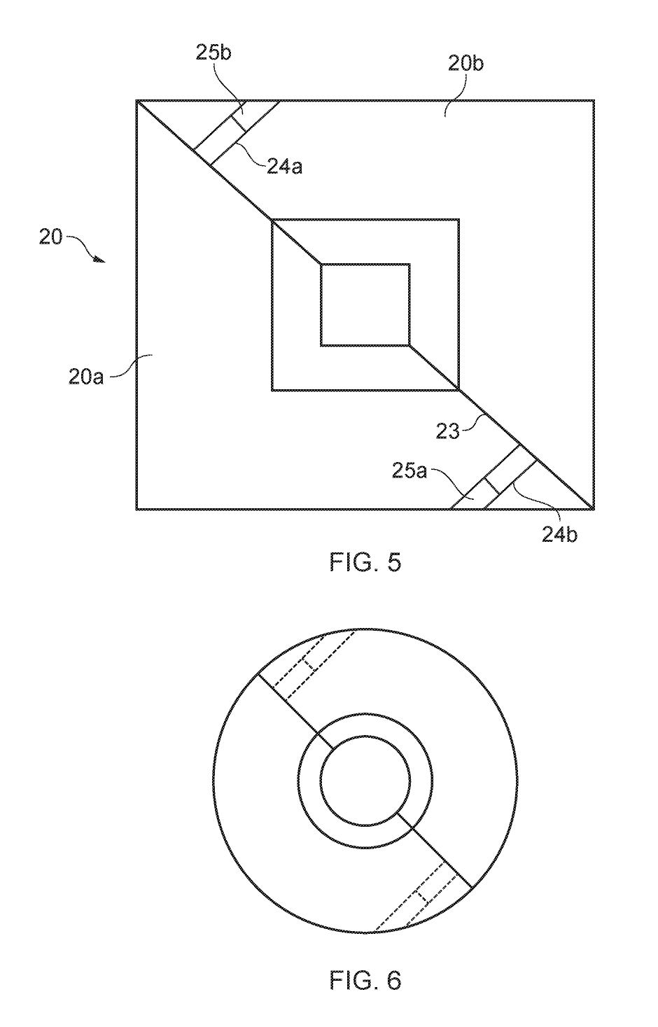

FIG. 5 is a plan view of the guide tool 20. The guide tool 20 is formed in two halves 20a, 20b joined at a split line 23. Each part has a dowel pin 24a,b which is received in a recess 25a,b in the other part. After the composite part 1 has cured, the guide tool 20 is removed by separating the two halves 20a,b of the guide tool 20. FIG. 6 is a plan view of an alternative guide tool for use with a cylindrical metal component.

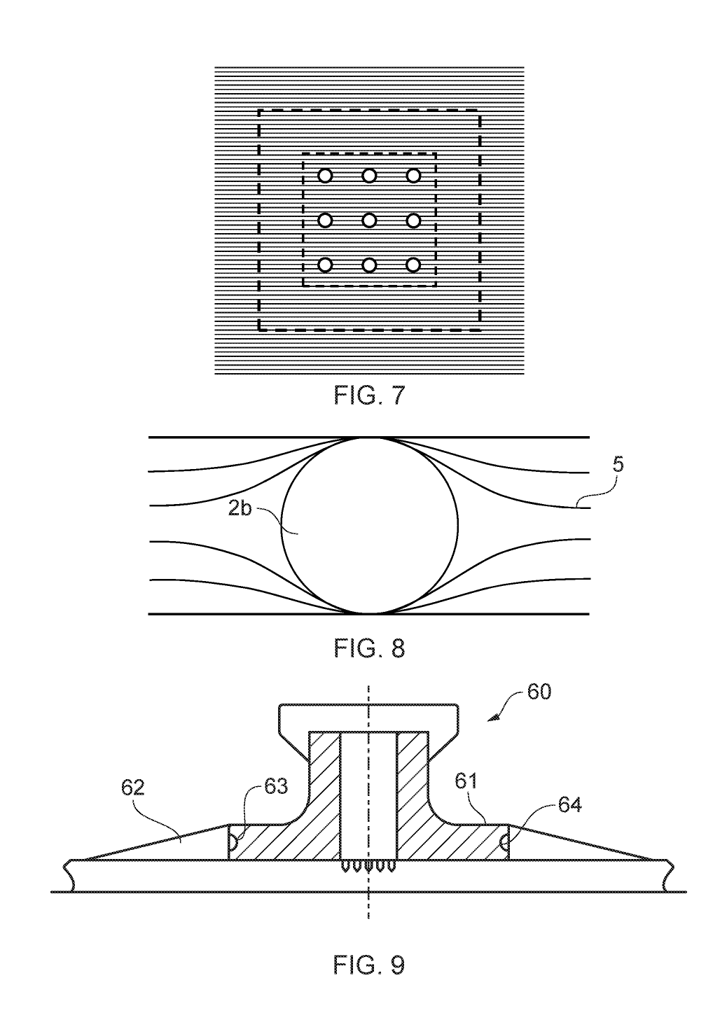

FIG. 7 shows the top ply of the composite component after the projections 2b have been inserted. As the projections pass through each ply, they pierce the epoxy resin matrix material and push apart the carbon fibres with minimal breakage or distortion. FIG. 8 is a schematic view of the fibres 5 passing round one of the embedded projections 2b. The minimal breakage or distortion of the fibres 5 reduces the impact of the joint on the mechanical properties of the composite component 1.

FIG. 9 shows an alternative guide tool 60. The guide tool 20 in the embodiment of FIG. 1 has a skirt 25 with a constant thickness, and hence a constant bending stiffness. This results in an abrupt step in the compression pressure applied to the composite component 1 at the edge of the skirt 25 which can result in through-thickness wrinkling of the fibres. The guide tool 60 of FIG. 9 has a skirt with an inner part 61 with a constant thickness, and an outer part 62 with a thickness which tapers from a maximum at its inner diameter to a minimum at its outer diameter. This tapered thickness results in a tapered bending stiffness and hence a less abrupt transition in compression pressure at the edge of the skirt. The outer part 62 of the skirt is formed from a different material to the rest of the guide tool—for instance the outer part 62 of the skirt may be made of rubber or any other material with a lower modulus of elasticity than the material of the rest of the guide tool. The outer part 62 of the skirt has an annular tongue 63 which fits into an annular groove 64 in the inner part 61 of the skirt.

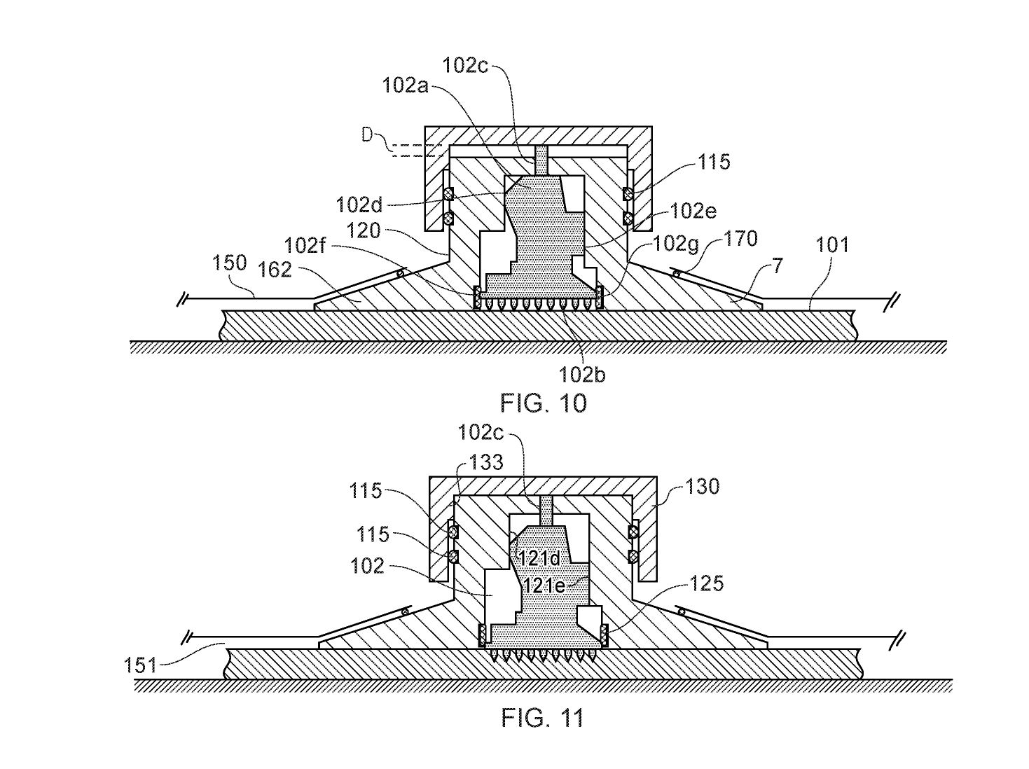

FIGS. 10 and 11 show a further alternative apparatus in which the membrane does not apply the insertion pressure to the metal component. A guide tool 120 is fitted into a hole in a membrane 150, and the membrane is sealed to the guide tool 120 around a periphery of the hole by sealant tape 170 to provide a gas-tight seal between the guide tool 120 and the membrane 150.

The bore in the guide tool 120 has a narrow cylindrical upper part which receives a cylindrical boss 102c protruding from the top of the metal part 102. When the tips of the projections 102b touch the composite component 101, the boss 102c protrudes slightly above the top of the guide tool 120 by a distance D equal to the length of the projections.

The body 102a of the metal part has a non-prismatic shape with parallel-sided features 102d, 102e which engage corresponding parallel side-portions 121d, 121e of the wall of the bore of the guide tool 120. A rubber seal member 125 is fitted at the bottom of the bore in order to prevent resin ingress. The body 102a of the metal part has parallel side-portions 102f, 102g which engage corresponding parallel side-portions of the seal member 125.

A cap 130 is fitted onto the guide tool 120 and covers the bore. As with the previous embodiment, the cap is slidably fitted onto the guide tool so the cap can move down in a sliding direction (i.e. the insertion direction) towards the bore. The inner diameter of the flange of the cap is formed with a shoulder 133 in contact with the guide tool 120 with a tight tolerance to enable the cap 130 to slide smoothly. In the previous embodiment the cap 30 is fully enclosed within the low-pressure volume 51, so there is no pressure drop across the cap 30. In the embodiment of FIG. 10, the cap 130 forms part of the barrier between the low-pressure volume 151 and the high-pressure volume of the autoclave chamber, so there is a pressure drop (P2−P1) across the cap 130.

The cap 130 has an upper face, with an area A1, directed away from the bore of the guide tool 120, which is exposed to the high pressure P2. The top of the boss 102c has an area A2 which contacts the lower face of the cap—this area A2 being approximately the same as the cross-sectional area of the narrow cylindrical upper part of the bore which contains the boss 102c. The area A1 is greater than the area A2. In this case the ratio A1/A2 is of the order of 200/1, so the insertion pressure P2=F/A2 applied by the cap to the boss 102c is greater than the fluid pressure difference (P2−P1) across the cap 130 by a factor of about two hundred.

The guide tool 120 has a skirt 162 with a tapering thickness, and hence a tapering bending stiffness.

A pair of O-rings 115 are fitted into annular grooves in the outer diameter of the guide tool 120. The O-rings providing an air-tight seal between the cap 130 and the guide tool 120, so that high pressure air from the autoclave chamber does not leak into the low-pressure volume 151.

The pressure difference across the cap 130 causes the cap 130 to push the projections 102b of the metal component into the composite component 101 until the lower face of the cap 130 contacts the guide tool as shown in FIG. 11. The parallel side-portions 121d, 121e of the wall of the bore of the guide tool 120 guide the metal part so it moves in a straight line during insertion.

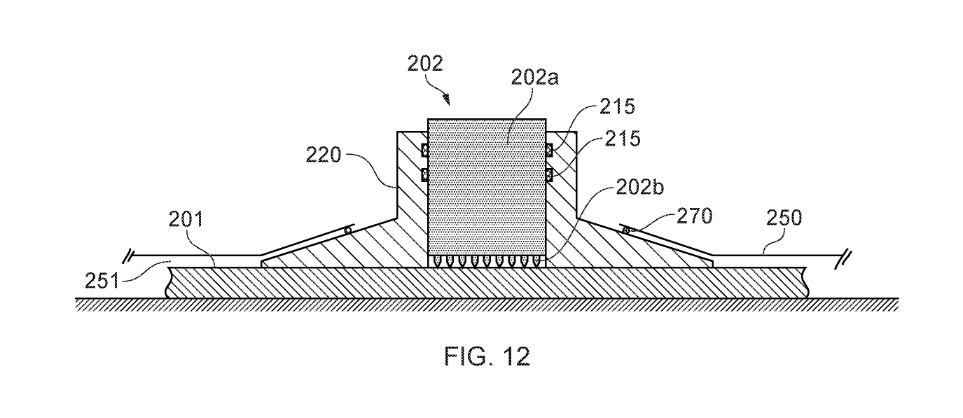

FIG. 12 shows a further alternative apparatus in which the membrane does not apply the insertion pressure to the metal component, and a pressure difference across the metal component generates the insertion pressure rather than a pressure difference across the cap 130 as in the embodiment of FIGS. 10 and 11. A guide tool 220 is fitted into a hole in a membrane 250, and the membrane is sealed to the guide tool 220 around a periphery of the hole by a seal member 270 to provide an air-tight seal between the guide tool 220 and the membrane 250.

A cylindrical bore in the guide tool 220 receives the cylindrical body 202a of the metal part 202. Unlike the previous embodiment, there is no cap. In the embodiment of FIG. 12, the body 202a of the metal part forms part of the barrier between the low-pressure volume 251 and the high-pressure volume of the autoclave chamber, so there is a pressure drop (P2−P1) across the body 202a of the metal part.

A pair of O-rings 215 are fitted into annular grooves in the inner diameter of the guide tool 220. The O-rings providing an air-tight seal between the metal part 202 and the guide tool 220, so that high pressure air from the autoclave chamber does not leak into the low-pressure volume 251.

The pressure difference across the body 202a of the metal part generates the insertion force which pushes the projections 202b into the composite component 201. The cylindrical wall of the bore of the guide tool 220 guides the metal part so it moves in a straight line during insertion.

In the embodiment of FIG. 12 there is no cap, so the insertion force caused by the air pressure is limited by the area of the upper face of the metal component 202. If this insertion force caused by the air pressure is not sufficient, then it may be supplemented by the action of a mechanical ram or other device pressing down on the metal component 202.

An advantage of the embodiments of FIGS. 11 and 12 is that the membrane 150, 250 does not need to be laid over the entirety of the guide tool 120, 220, so it is less likely to suffer from wrinkling.

In the embodiments described above, the first component is a composite component 1, 101, 201 made of a stack of plies of “prepreg” composite material. In alternative embodiments of the invention, the first component may instead be a dry-fibre preform made of dry fibres not yet impregnated with a matrix. As with the “prepreg” embodiments, the fibres of the preform are pushed apart with minimal breakage as the projections are embedded. During the insertion process, the dry fibre preform is compressed by the compression pressure applied by the membrane and the guide tool. During or after the insertion of the projections, an epoxy resin (or other liquid matrix material) is injected into the low-pressure volume 51, 151, 251 so that it infuses the dry-fibre preform. After the preform is fully infused, and the projections are fully inserted, the matrix material is cured to adhere the matrix material to the metal component. The infused preform continues to be compressed by the membrane and the guide tool during the cure process, thereby assisting consolidation of the infused preform.

In the embodiments described above, the process is performed in an autoclave chamber 40, and the pressure differential P2−P1 is generated by increasing the pressure P2 in the autoclave chamber, the pressure P1 in the low-pressure volume 51, 151, 251 remaining at atmospheric pressure. In a first alternative embodiment, the low-pressure volume 51, 151, 251 may be evacuated via a vacuum port to reduce the pressure P1 and thus increase the pressure differential P2−P1. The vacuum port also provides a route for volatile gasses to escape the low-pressure volume during the curing process. The evacuation of the low-pressure volume can also help to draw the liquid matrix material through the dry-fibre preform during the infusion process mentioned above. In a further alternative embodiment, the process may be performed out of autoclave. In this case the pressure P2 is atmospheric pressure, and the low-pressure volume 51, 151, 251 is evacuated to reduce the pressure P1 and thus create the pressure differential P2−P1. In this case the pressure differential P2−P1 can be no greater than one atmosphere, so the insertion force caused by the pressure differential may not be sufficient. In this case it may be supplemented by the action of a mechanical ram or other device pressing down on the metal component. An out-of-autoclave process is particularly suited to joining a metal component to a composite component with a thermoplastic matrix material, rather than the thermosetting matrix material in the embodiments described above.

In the embodiments above a non-permeable membrane 50, 150, 250 is laid over the assembly and sealed to the master tool to provide a sealed low-pressure volume 51, 151, 251 between the master tool and the membrane. In alternative embodiments of the invention, the membrane is a bag which is laid on top of the master tool and contains the other parts of the assembly. In this case the interior of the bag provides the low-pressure volume.

In summary, the methods described above join a first component 1, 101, 201 to a second component 2, 102, 202. A membrane 50, 150, 250 is provided between the first component and pressurised gas in the autoclave chamber 40. Pressure of the gas is used to apply a compression force to a first part 1a,b of the first component via the membrane. The pressure of the gas is also used to apply an insertion force to the second component which pushes the projections 2b of the second component into a second part 1c of the first component. The methods described above can increase production rate, provide improved process control, and improve quality of the final part.

Although the invention has been described above with reference to one or more preferred embodiments, it will be appreciated that various changes or modifications may be made without departing from the scope of the invention as defined in the appended claims.

1. A method of joining a first component to a second component, the method comprising: providing a membrane between the first component and a fluid; using pressure of the fluid to apply a compression force to a first part of the first component via the membrane; and also using the pressure of the fluid to apply an insertion force to the second component which pushes projections of the second component into a second part of the first component.

2. The method of claim 1, wherein the pressure of the fluid applies the compression force to the first part of the first component via a first part of the membrane; and the pressure of the fluid applies the insertion force to the second component via a second part of the membrane.

3. The method of claim 2, wherein the second part of the membrane applies the insertion force to the second component via an insertion member.

4. The method of claim 3, wherein the pressure of the fluid causes a fluid pressure difference across the membrane; and an insertion pressure applied by the insertion member to the second component is greater than the fluid pressure difference across the membrane.

5. The method of claim 1, further comprising providing an insertion member; wherein the pressure of the fluid causes a fluid pressure difference across the insertion member; and the fluid pressure difference across the insertion member generates the insertion force.

6. The method of claim 5, wherein an insertion pressure applied by the insertion member to the second component is greater than the fluid pressure difference across the insertion member.

7. The method of claim 1, wherein the pressure of the fluid causes a fluid pressure difference across the second component; and the fluid pressure difference across the second component generates the insertion force.

8. The method of claim 1, further comprising fitting the second component into a guide tool; and guiding the second component with the guide tool as the projections of the second component are pushed into the second part of the first component.

9. The method of claim 8, wherein the membrane applies the compression force to at least part of the first component via the guide tool.

10. The method of claim 8, wherein the guide tool is fitted into a hole in the membrane; and the membrane is sealed to the guide tool around a periphery of the hole to provide a fluid-tight seal between the guide tool and the membrane so that the fluid cannot leak between the membrane and the guide tool.

11. The method of claim 1, further comprising increasing the pressure of the fluid in order to generate the compression force and the insertion force.

12. The method of claim 1, wherein the second component has a body; and the projections extend from the body.

13. The method of claim 12, wherein the body and the projections are made of the same material.

14. The method of claim 12, wherein the body is metallic and the projections are metallic.

15. The method of claim 12, wherein the projections do not penetrate the body.

16. Apparatus for joining a first component to a second component by the method of claim 1, the apparatus comprising: a membrane; and a guide tool with a parallel-sided bore for receiving the second component and guiding the second component as the projections of the second component are pushed into the first component.

17. The apparatus of claim 16, wherein the guide tool has a skirt with a tapered bending stiffness for applying the compression force to the first component.

18. The apparatus of claim 16, wherein the guide tool is fitted into a hole in the membrane; and the membrane is sealed to the guide tool around a periphery of the hole to provide a fluid-tight seal between the guide tool and the membrane.

19. The apparatus of any claim 16, further comprising a cap fitted onto the guide tool covering the bore, wherein the cap is slidably fitted onto the guide tool so the cap can move in a sliding direction towards the bore, the cap has a face directed away from the bore, the face has an area A1, the bore has a cross-sectional area A2 transverse to the sliding direction, and the area A1 is greater than the area A2.

20. The apparatus of claim 19, further comprising a seal member providing a fluid-tight seal between the cap and the guide tool.
